(19) United States
(12) Patent Application Publication
(10) Pub. No.: US 2008/0067219 A1
(43) Pub. Date: Mar. 20, 2008

(54) Apparatus and Method for Wave Soldering

(75) Inventors: Stefano Barengo, Legnano (IT); Ernst Wandke, Geretsried (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/576,629

(22) PCT Filed: Sep. 27, 2005
(86) PCT No.: PCT/EP05/10430

§ 371 Date: Sep. 27, 2007

(30) Foreign Application Priority Data
Oct. 5, 2004 (DE) 10 2004 048 474.0

(51) Int. Cl. B23K 31/02; B23K 1/08

(52) U.S. Cl. 228/219; 228/37

(57) ABSTRACT

A device and method for wave soldering work pieces is disclosed which moves the workpiece to undergo soldering along a specific path across at least one wave of solder created by a solder reservoir. An inert gas atmosphere is located above the solder reservoir, with oxygen largely excluded, where the path runs such that at least one part of the workpiece comes into contact with the wave of solder. A hood and tubes to supply the inert gas below the workpiece are provided. To prevent flooding, two or more tubes are provided with upwardly directed holes or slits which are covered by U-shaped protective housings which are open in a substantially downward direction.

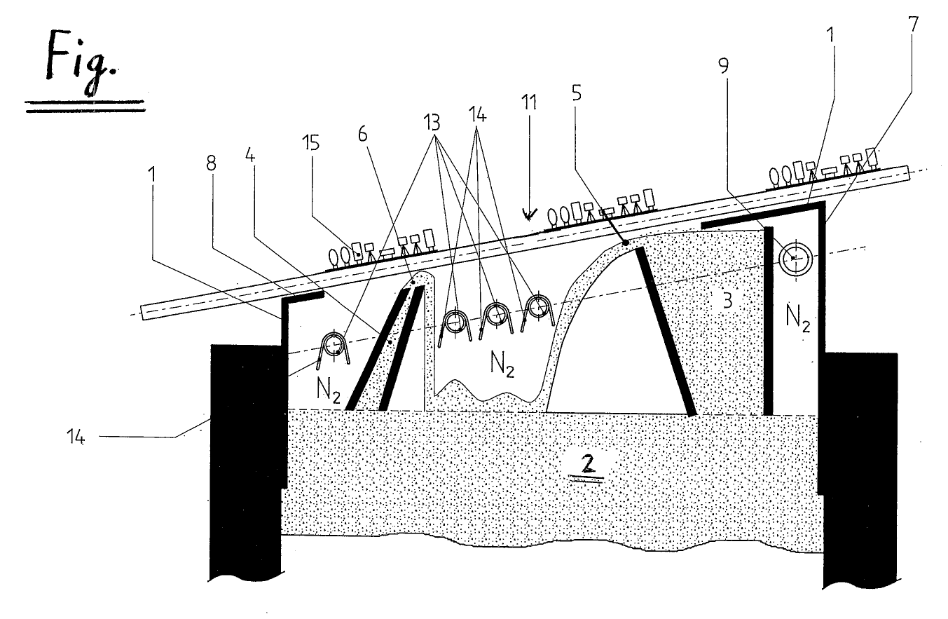

### BACKGROUND AND SUMMARY OF THE INVENTION

This application claims the priority of International Application No. PCT/EP2005/010430, filed Sep. 27, 2005, and German Patent Document No. 10 2004 048 474.0, filed Oct. 5, 2004, the disclosures of which are expressly incorporated by reference herein.

The invention relates to a device and method for wave soldering workpieces. The workpiece which is to undergo soldering treatment is passed across at least one wave of solder created by means of a solder reservoir, where an inert gas atmosphere is created above the solder reservoir, with oxygen largely excluded, and at least one part of the workpiece is brought into contact with the wave of solder.

Such soldering devices are known from German Patent Document Nos. DE 195 41 445 A1 or DE 298 23 860 U1. In these methods, the wave of solder is bathed with inert gas only underneath the workpiece. In contrast to other methods of introducing inert gas above and below the workpiece, the result is that only relatively little inert gas is consumed. However, the disadvantage is that with wave parameters which fluctuate severely, far exceeding the normal solder settings, the result can be “flooding” of the lower part of the hood with solder, with the result that the solder hardens and, with repeated flooding, builds up so high that the printed circuit boards have to be stopped.

The device from DE 298 23 860 U1 uses porous tubes with a specified pore size to supply nitrogen. Frequently, these tubes break as the result of thermal or mechanical stress so that the inert gas can flow out unchecked. The uniformity of gas distribution is barely ensured with a porous tube.

The object of the invention is to improve a soldering device for wave soldering such that it is safe from flooding and at the same time always provides the desired, preset volume of inert gas.

In accordance with the invention, instead of large cover plates below the workpieces, two or more tubes are provided which have holes or slits directed upward and which are surrounded by U-shaped protective housings which are open in a substantially downward direction. Flooding as the result of incorrect adjustment of the waves of solder is reliably prevented. These two, three, four or five gas supplies provide an inerting screen which can be installed relatively freely below the workpieces inside the overall hood. The slits or holes provide a specified gas supply since their cross-sectional size is and always remains predictable in advance. The U-shaped protective housings prevent clogging of the slits with solder or contamination so that, in this way also, the desired inflow of gas is always available. The gas is blown downward towards the solder bath and renders the entire space above the solder path and below the workpiece inert. Dripping solder can no longer block the access openings, beading off downward instead from the protective housings. The space directly in the area of the flow of the waves is effectively and extensively protected by an inerting screen, but is also permeable for the flowing solder.

In one embodiment of the invention, the protective housings are made from, or coated with, titanium, which has the advantage that solder splashes do not adhere but bead and drop off.

In a preferred embodiment, the distance of the individual protective housings from each other is >3 mm. This has the advantage that solder beads can always run off and do not plug the passages for the solder, even if the operator adjusts for too much solder or solder waves.

The advantage for the customer is that, beyond the increased variability, practically all solder bath shapes and operating parameters can be covered. When switching to lead-free solder, the device can be used without any conversion. Atmospheric soldering machines which were not able to be converted to nitrogen until now, can be converted easily.

Nitrogen, carbon dioxide, argon, helium, sulfur hexafluoride or mixtures of these can be used, even with the admixture of hydrogen.

### BRIEF DESCRIPTION OF THE DRAWING

The invention is explained hereinafter in more detail with reference to an embodiment shown in a FIGURE.

### DETAILED DESCRIPTION OF THE DRAWING

In the FIGURE, 1 designates a hood which houses the solder bath 2, including the areas of the solder waves 3, 4. An opening remains for the wave crests 5, 6 required for the soldering process. A gas diffuser 9, which, if necessary, can also be replaced by a tube 13 in accordance with the invention, is located below the right part 7 of the hood 1. On the left part 8 and in the center part 11, tubes 13 in accordance with the invention are located which are slotted or perforated on their upper side and which are surrounded by protective housings 14. The protective housings 14 have a substantially U-shaped cross-section, where the ends can be parallel to each other, be inclined towards each other or—as shown in the FIGURE—point slightly away from each other. As can be seen clearly in the FIGURE, the protective housings are pointed essentially downward, protect the tubes 13 and their exit slits or holes and direct the nitrogen or other inert gas into the space below, from where it spreads over the entire space to be rendered inert—all the way up to the workpiece 15. The tubes 13 and their protective housings 14 are arranged in this embodiment in a row (dot-dash line), but can also be arranged differently. The gas is fed in through the tubes 9 and 13, which achieves a very even distribution of gas with a low gas flow across the entire width of the wave. The gas guide plates 14 provide a flow approximately parallel to the surfaces of the waves. Gas consumption is relatively low and, depending on the design layout, is between 3 and 10 m³/h. The low flow velocity allows practically no blockage from dross. A residual oxygen content of 500 ppm, 150 ppm at the moment the workpiece 15 passes across, is achieved between the waves 3, 4.

Four tubes 9 are shown in the FIGURE, where three tubes lie relatively close to each other, and the fourth tube gasifies the space to the left of the wave 6. Naturally, fewer tubes can be used, such as two, or more tubes, such as five or six. The inerting screens can be adapted very simply to the existing equipment and to the number of wave crests 5, 6. In accordance with the invention, the result is a very flexible arrangement of gas diffusers which have a long life and meter the required quantity of gas reliably.

A distance of more than 3 mm always is maintained between the housings 14 at the lower edge so that solder splashes and solder drops can run off from the protective housings 14 and not form blockages since solder drops are usually smaller than 3 mm. Solder backup in a flood is thus prevented since the solder droplets always run back into the bath 2.

1-3. (canceled)

4. A device for wave soldering a workpiece which has means to move the workpiece to undergo soldering along a specific path across a wave of solder generated by means of a solder reservoir, where an inert gas atmosphere is located above the solder reservoir, with oxygen largely excluded, where the path runs such that at least one part of the workpiece comes into contact with the wave of solder, where a hood and tubes to supply the inert gas below the workpiece are provided, and wherein two or more of the tubes have upwardly directed slits or holes and each is covered by a respective U-shaped protective housing which is open in a substantially downward direction.

5. The device according to claim 4, wherein the protective housings consist of titanium at least on an outside.

6. The device according to claim 4, wherein a distance between the protective housings is greater than 3 mm.

7. An apparatus for wave soldering a workpiece, comprising:
a workpiece path;
a solder reservoir disposed under the workpiece path; and
an inert gas supply tube disposed between the workpiece path and the solder reservoir, wherein a U-shaped housing is disposed over the tube.

8. The apparatus according to claim 7, wherein the solder reservoir is disposed within a hood.

9. The apparatus according to claim 8, wherein the hood defines a first and a second wave of solder and wherein the inert gas supply tube is disposed between the first and second waves of solder.

10. The apparatus according to claim 9, wherein the hood is not disposed over the inert gas supply tube in a space defined between the workpiece path and the inert gas supply tube.

11. The apparatus according to claim 7, further comprising a second inert gas supply tube disposed between the workpiece path and the solder reservoir, wherein a second U-shaped housing is disposed over the second tube, and wherein a distance between the housing and the second housing is greater than 3 mm.

12. The apparatus according to claim 7, wherein the housing includes titanium.

13. A method for wave soldering a workpiece, comprising the steps of:
passing the workpiece across a wave of solder formed from a solder reservoir; and
creating an inert gas atmosphere under the workpiece by supplying an inert gas through a supply tube, wherein the supply tube is disposed under a path of the workpiece and wherein a U-shaped housing is disposed over the tube.

14. The method according to claim 13, wherein the step of supplying the inert gas though the supply tube includes the step of supplying the inert gas through slits in the supply tube.

15. The method according to claim 13, further comprising the step of preventing the solder from contacting the supply tube.

16. The method according to claim 15, wherein the step of preventing the solder from contacting the supply tube includes the step of diverting a solder drop from the supply tube by the U-shaped housing.

17. The method according to claim 16, further comprising the steps of:
supplying the inert gas through a second supply tube, wherein the second supply tube is disposed under the path of the workpiece and wherein a second U-shaped housing is disposed over the second supply tube; and
preventing the solder from contacting the second supply tube by diverting a second solder drop from the second supply tube by the second U-shaped housing;
wherein the first and second solder drops drop from the first and second U-shaped housings, respectively, into the solder reservoir though a space defined between the first and second housings.

18. The method according to claim 17, wherein the space is greater than 3 mm.
